(19) United States
(12) Patent Application Publication
(10) Pub. No.: US 2025/0112244 A1
(43) Pub. Date: Apr. 3, 2025

(54) Solid-State Battery, and Method for Producing the Same

(71) Applicant: COMMISSARIAT A L'ENERGIE ATOMIQUE ET AUX ENERGIES ALTERNATIVES, Paris (FR)

(72) Inventors: Jacopo CELE, Grenoble (FR); Sami OUKASSI, Grenoble (FR); Maude BERT, Grenoble (FR); Jean-Philippe COLONNA, Grenoble (FR)

(73) Assignee: COMMISSARIAT A L'ENERGIE ATOMIQUE ET AUX ENERGIES ALTERNATIVES, Paris (FR)

(21) Appl. No.: 18/897,261

(22) Filed: Sep. 26, 2024

(30) Foreign Application Priority Data
Sep. 29, 2023 (FR) 2310451

(51) Int. Cl. H01M 4/62; H01M 4/02; H01M 4/04; H01M 10/04; H01M 10/0562

(52) U.S. Cl. CPC H01M 4/628; H01M 4/0492; H01M 10/0436; H01M 10/0562; H01M 2004/021; H01M 2010/0495; H01M 2220/30; H01M 2300/0071

(57) ABSTRACT

This invention relates to a solid-state battery and its production method.

This invention relates to a solid-state battery and a method for producing the same.

The electronic components are found in many portable apparatuses such as computers, mobile phones, tracking systems, optical readers, remote controls, etc. One of the drawbacks of these portable apparatus is the need to include a power supply. The portable apparatuses generally use batteries as their power source. The batteries must have sufficient capacity to power the device for at least the duration of its use. Sufficient battery capacity may mean that the power pack is rather heavy and/or bulky compared to the rest of the apparatus. It is therefore desirable to have smaller and lighter batteries with sufficient energy storage capacity. Other energy storage devices, such as the supercapacitors, and energy conversion devices, such as photovoltaic cells and fuel cells, are alternatives to batteries for the power supply of portable electronic apparatus or non-portable electrical applications, as appropriate. Another disadvantage of conventional batteries is that some are made from potentially toxic materials that can leak and are subject to government regulations. It is therefore necessary to provide a safe source of electrical energy that can be recharged over many charge/discharge cycles.

In this context, a particular type of energy storage device has been developed: solid-state batteries, in particular thin-film batteries.

A solid battery, also known as a solid electrolyte battery or an all solid-state battery, refers to a type of electrical accumulator in which the electrolyte, placed between the anode and cathode, is solid, in the form of a glass plate, for example made of lithium phosphate, or a gel.

This type of battery is seen as a replacement for lithium-ion batteries, not only because of its higher energy density, but also because of its higher operating temperature range: from −20° C. to over 100° C., compared with 15° C. to 35° C., as well as the lower risk of flashover or explosion. In a battery, the positive ions move between the negative and positive electrodes via an ion conductor and deliver electrons to generate an electric current. In conventional batteries, such as the lithium-ion batteries, the ion conductor is a highly combustible liquid organic compound, which is a major drawback.

Various research and development programmes have enabled a variety of compounds to be synthesised in order to find high-performance solid conductors to replace liquid electrolytes. Researchers have discovered a solid-state ionic electrolyte whose performance exceeds that of conventional lithium-ion electrolytes: the solid sulphide electrolyte LGPS (LGPS: lithium, germanium, phosphorus, sulphur).

In the general context of battery electrodes, the available capacity, in particular the capacity available as a function of the power supplied, is an essential parameter for evaluating a device incorporating these electrodes, as is the speed at which it is possible to charge and discharge the battery. It is well known in the literature that increasing the discharge/charge current of a battery reduces the capacity that the battery is able to deliver (coulombic efficiency).

Typically, to overcome these disadvantages, the active material can be mixed with a good electronic conductor (such as carbon) or incorporated into a conductive matrix. In this case, the material of the cathode is embedded in a carbon matrix. EP3809491 is an example of this approach. As shown in FIG. 5, the carbon matrix reduces capacitance loss at high current densities.

The main limitation of this approach is the reduction in total capacity: part of the volume is used for the conductive matrix, which offers no storage properties. Compared with a 100% active electrode, the capacity will be reduced. Furthermore, this approach is not easily applicable to solid-state thin-film batteries.

One aim of the invention is therefore to provide batteries, particularly thin-film solid batteries, for which the loss of capacity during charge/discharge cycles is reduced or even eliminated.

Another aim of the invention is therefore to make it possible to obtain such advantages, in particular during the first charge, on solid batteries, in particular thin-film batteries of the LiCoO₂ type.

The invention relates to a solid-state battery comprising an electronic and ion conductive film separating an electrolyte film and an electrode film, said electronic and ion conductive film constituting or forming part of the current collector of the electrode.

In particular, said current collector of the electrode comprises a first collector part being said electronic and ion conductive film, at the electrode-electrolyte interface, as well as a second collector part located on one side of the electrode, as illustrated in FIG. 1.

By “separating the electrolyte film and an electrode film” is meant in particular that the electronic and ion conductive film is in contact with both the electrolyte film and an electrode film, said electrolyte film and electrode film not being in contact with each other, or, in the case of a grid, in particular a metal grid, the electrolyte and electrode are in contact via the holes in the grid.

The invention also relates to a solid-state battery comprising an electronic and ion conductive film between an electrolyte film and an electrode film, said electronic and ion conductive film forming part of the current collector of the electrode, and allowing a partial contact between the electrolyte and the electrode, possibly via an ion and optionally electronic conductive material.

This is illustrated in FIG. 3, for example.

Any “ion conductive material” present is taken to mean in particular an ion conductive material other than the electrolyte as defined above.

In the absence of said ion conductive material, the electrolyte plays the role of the ion conductive material of the electronic and ion conductive film.

By “partial contact” we mean in particular contact in at least one zone of the electronic and ion film, said zone not representing the whole of said electronic and ion film.

In particular, the conductive film is not continuous.

According to a particular embodiment, the contact surface between the electrolyte and the electrode, in particular the cathode, is at least 10% of the total surface area of the electrode, preferably between 20 and 75% of the total surface area of the electrode.

This contact is made in particular at the level of at least one opening in an electronic conductive material of the electronic and ion film.

By “at the level of at least one opening in an electronic conductive material of the electronic and ion film”, we mean in particular at least one opening in the film of electronic conductive material, comprising the electrolyte and/or electrode as defined above.

According to a particular embodiment, said at least one opening comprises, in particular only, the electrolyte, cathode electrode, or electrolyte and electrode as previously defined.

According to a particular embodiment, said at least one opening comprises, in particular only, electrolyte, or electrolyte and electrode as previously defined. In this case, the electrolyte, particularly within said at least one opening, acts as the ion conductive material of the electronic and ion conductive film.

According to a particular embodiment, said at least one opening comprises, in particular only, electrode as defined above. In this case, the electrolyte, particularly the electrolyte in contact with the electrode, acts as the ion conductive material of the electronic and ion conductive film.

The invention also relates to a solid-state battery comprising an electronic conductive film between an electrolyte film and an electrode film, said electronic conductive film forming part of the current collector of the electrode, and allowing partial contact between the electrolyte and the electrode, possibly via an ion and optionally electronic conductive material.

In this way, the electrolyte, particularly the electrolyte in contact with the electrode, and possibly the ion conductive material, act(s) as ion conductors.

More particularly, said electric and ion conductive film consists of or comprises at least one electronic conductive material and at least one ion conductive material, said electronic conductive material comprising at least one opening, in particular a plurality of openings, said electric and ion conductive film allowing partial contact between the electrolyte and the electrode, possibly via an ion and optionally electronic conductive material.

Even more particularly, said electric and ion conductive film consists of or comprises at least one electronic conductive material and at least one ion conductive material, said electronic conductive material comprising at least one opening, in particular a plurality of openings, said electric and ion conductive film allowing partial contact between the electrolyte and the electrode, possibly via an ion and optionally electronic conductive material, at the level of said at least one opening.

Even more particularly, said electric and ion conductive film consists of or comprises at least one electronic conductive material and at least one ion conductive material, said electronic conductive material comprising at least one opening, in particular a plurality of openings, said electric and ion conductive film allowing a partial contact between the electrolyte and the electrode at the level of said at least one opening. In this case, the ion conductive material is the electrolyte as defined above.

According to a particular embodiment, the invention relates to a solid-state battery comprising an electronic and ion conductive film between an electrolyte film and a cathode electrode film,

said electronic and ion conductive film forming part of the current collector of the electrode, and allowing partial contact between the electrolyte and the cathode electrode, an ion and optionally electronic conductive material.

According to a particular embodiment, the invention relates to a solid-state battery comprising an electronic and ion conductive film between an electrolyte film and an electrode film,

said electronic and ion conductive film forming part of the current collector of the electrode, and allowing partial contact between the electrolyte and the cathode, an ion and optionally electronic conductive material.

According to a particular embodiment, said electronic and ion conductive film comprises at least one electronic conductive material and optionally ion and at least one ion conductive material and optionally electronic.

According to a particular embodiment, said electronic and ion conductive film comprises at least one electronic conductive material and optionally ion and at least one ion conductive material.

According to a particular embodiment, said electronic and ion conductive film comprises at least one electronic conductive material and at least one ion conductive material.

According to a particular embodiment, said ion conductive material is the electrolyte as defined above.

According to a particular embodiment, said electronic conductive material comprises at least one opening, in particular a plurality of openings.

According to a particular embodiment, said electronic conductive material comprises at least one opening, in which the electrolyte and the electrode, in particular the cathode electrode, are in contact, an ion and optionally electronic conductive material.

According to a particular embodiment, said electronic conductive material comprises at least one opening, in which the electrolyte and the electrode, in particular the cathode electrode, are in contact, via an ion conductive material.

This ion conductive material is in particular the electrolyte as defined above. In this case, the invention relates more particularly to a solid-state battery comprising an electronic and ion conductive film between an electrolyte film and an electrode film,

said electronic and ion conductive film forming part of the current collector of the electrode, and comprising an electronic conductive material comprising at least one opening, allowing partial contact between the electrolyte and the electrode.

In this case, it is the electrolyte that acts as the ion conductive material of the electronic and ion conductive film.

In a particular embodiment, the invention relates to a solid-state battery comprising an electronic and ion conductive film separating an electrolyte film from a cathode electrode film, said electronic and ion conductive film forming part of the cathode current collector.

FIG. 1 shows a battery according to the present invention.

According to a particular embodiment, the invention relates to a battery comprising:
an anode current collector in contact with an electrolyte film;
an electronic and ion conductive film separating the electrolyte film from a cathode electrode film;
   said electronic and ion conductive film forming part of the cathode current collector.

According to a particular embodiment, the invention relates to a battery comprising:
an anode current collector in contact with an anode electrode film;
an electrolyte film in contact with the anode electrode film;
an electronic and ion conductive film separating the electrolyte film from a cathode electrode film;
   said electronic and ion conductive film forming part of the cathode current collector.

By “separating the electrolyte film from a cathode electrode film” is meant in particular that the electronic and ion conductive film is in contact with both the electrolyte film and the cathode electrode film, said electrolyte film and cathode electrode film not being in contact with each other, or, in the case of a grid, in particular a metal grid, the electrolyte and cathode are in contact via the holes in the grid. As part of the cathode current collector, said electronic and ion conductive film can be bonded to the positive pole of the battery.

In a particular embodiment, the invention relates to a solid-state battery comprising an electronic and ion conductive film separating an electrolyte film from an anode electrode film, said electronic and ion conductive film forming part of the current collector of the anode.

The anode electrode may, for example, be an insertion anode electrode.

As part of the anode current collector, said electronic and ion conductive film can be bonded to the negative pole of the battery.

The batteries in question are, in particular, fully solid-state batteries.

In particular, solid-state thin-film batteries, especially fully solid-state thin-film batteries, which may also be referred to as solid-state thin-film batteries, especially fully solid-state thin-film batteries, respectively.

According to a particular embodiment, the electronic and ion conductive film has a thickness of 10 nm to 1 μm.

According to a particular embodiment, the cathode electrode film has a thickness E of 1 μm to 200 μm.

According to a particular embodiment, the electronic and ion conductive film has a thickness of from 10 nm to E/2, E being the thickness of the cathode electrode film as described above.

According to a particular embodiment, the invention relates to a thin-film battery in which:
the anode current collector has a thickness of between 10 nm and 10 μm; and/or
the anode electrode film has a thickness greater than 0 and less than or equal to 200 μm; and/or
the electrolyte film has a thickness of between 10 nm and 10 μm.
the cathode electrode film has a thickness of between 1 μm and 200 μm.
the electronic and ion conductive film is between 20 nm and 1 μm thick.

By “electronic conductive film” we mean that the film allows the electrons to pass from the electrolyte film to the cathode electrode film, and from the cathode electrode film to the electrolyte film.

According to a particular embodiment, said electronic and ion conductive film has an electrical conductivity of at least 10⁻³ S·cm⁻¹. For example, the electrical conductivity can range from 10⁻³ to 10⁸ S·cm⁻¹.

“Ion conductive film” means that the film allows ions, in particular lithium ions, to pass from the electrolyte film to the cathode electrode film and from the cathode electrode film to the electrolyte film.

According to a particular embodiment, said electronic and ion conductive film has an ionic conductivity of at least 10⁻⁶ S·cm⁻¹. For example, the ionic conductivity can be between 10⁻⁸ and 10² S·cm-1.

According to a particular embodiment, said electronic and ion conductive film is made of or comprises at least one electronic and ion conductive material.

According to a particular embodiment, said electronic and ion conductive film consists of or comprises a material M chosen from:
The optionally doped metals, in particular selected from Si, Sn, Al and As, and their alloys;
The carbon-based materials, in particular selected from the mesocarbon microbeads (MCMB), highly ordered pyrolytic graphite (HOPG), hard carbons and soft carbons;
LiTiO₂ (corresponding to the state of TiO₂ after lithium insertion); and/or
LiFePO₄.

The metals can be doped with B, As or P. The dopant is then present at <1% in the metal or its alloys.

According to a particular embodiment, said electronic and ion conductive film contains the material M in a proportion of 95% to 100% by mass, more particularly M in a proportion of 100% by mass. By “up to ( . . . ) by mass” is meant the percentage of the mass of the material M in the total mass of the electronic and ion conductive film.

According to a particular embodiment, said electric and ion conductive film is made of or comprises at least one electronic conductive material and at least one ion conductive material. A battery of the invention comprising such a film is illustrated in FIG. 2.

According to a more particular embodiment, said electronic and ion conductive film is made of or comprises an electronic conductive material and an ion conductive material.

Said electronic conductive material is, in particular, in the form of a grid.

By “grid” we mean, in particular, a perforated layer or plate, or an assembly of interwoven or parallel wires or bars.

Said (at least one) electronic conductive material may be selected from:
The metals, for example Pt, W, Al, Cu, Au or Ti, in particular in grid form.

The ion conductive material is, in particular, an electrolyte, particularly a solid electrolyte. These electrolytes are well known in the literature.

Said (at least one) ion conductive material may be selected from:
The solid electrolytes, in particular LiPON (lithium phosphorus oxynitride), LLTO (lithium lanthanum titanate), LLZO (Li7La3Zr2O12), LPS (lithium phosphorus sulphide), LTP (lithium titanium phosphate), LZP (lithium zirconium phosphate), LiSiON (lithium silicon oxynitride), LAGP (lithium aluminium germanium phosphate), LGPS (lithium germanium phosphorus sulphide), and optionally based on PEO (poly (ethylene oxide)), and in particular the solid electrolyte constituting or included in the electrolyte film of the present battery of the invention.

The nature of the anode current collector, the anode electrode film, the electrolyte film and the anode electrode film, well known to the state of the art, can easily be determined by the person skilled in the art.

For example:
the anode current collector is made of or comprises a material selected from Ti, Pt, Cu, Al, Au, W, TiN, doped Si, for example Ti;
the anode electrode film consists of or comprises a material selected from Li, Al, C, In₂O₃, Si, SnO₂, TiO₂, V₂O₅, being for example Li;
the electrolyte film consists of or comprises a material chosen from LiPON, LLTO, LLZO, LPS, LTP, LZP, LiSiON, LIN, LAGP, LGPS, based on PEO, being for example LiPON; and/or
the cathode electrode film is made of or comprises a material selected from LiCoO₂, LiFePO₄, LiMn₂O₄, LiNiO₂, LiV₃O₈, LiMOO₃, LiV₂O₅, NMC, being for example LiCoO₂. By way of example, methods for producing such films are described in Liu et al. (Advanced Materials, vol. 26, no. 37, pp. 6472-6477, 2014), Tadanaga et al. (Materials Research Bulletin, vol. 53, pp. 196-198, 2014), et Liu et al. (Electrochimica Acta, vol. 56, no. 3, pp. 1392-1398, 2011).

According to a particular embodiment, the anode and/or cathode of the battery of the invention is (are) of the AAM (“All Active Material”) type.

By “AAM type” we mean in particular that the electrode is free of non-active additives.

By “free”, we mean in particular that the electrode, in particular of the thin-film battery, contains less than 5%, or even less than 1%, of the total mass of the electrode, by mass, of non-active additives.

According to a particular embodiment, the cathode electrode film is also in contact with a substrate.

The nature of the substrate, which is well known in the art, can easily be determined by a person skilled in the art.

The substrate is for example made of or comprises a material being SiO₂ or Si.

According to a more particular embodiment, the substrate is conductive.

In a particular embodiment, the solid-state battery additionally comprises a current collector element between the substrate and the electrode. In this case, this element forms part of the electrode's current collector, as does the electronic and ion conductive film.

According to a particular embodiment, the anode current collector film is also in contact with a passivation film.

The nature of this passivation film, which is well known in the art, can easily be determined by a person skilled in the art.

For example, the passivation film consists of or comprises a material that is parylene (PPX).

According to a more particular embodiment, the anode current collector film is additionally in contact with a passivation film, said anode current collector film and passivation film also being in contact with a redistribution film (also known as a contact recovery film or RDL).

The redistribution film is for example made of or comprises a material being titanium.

Thus, a battery according to the invention comprises a stack in the order shown below:
cathode electrode film;
electronic and ion conductive film forming part of the cathode current collector;
electrolyte film; and
anode current collector;
   or a stack in the order shown below:
cathode electrode film;
electronic and ion conductive film forming part of the cathode current collector;
electrolyte film;
anode electrode film; and
anode current collector;
   or a stack in the order shown below:
substrate;
cathode electrode film;
electronic and ion conductive film forming part of the cathode current collector;
electrolyte film;
anode electrode film; and
anode current collector;
   or a stack in the order shown below:
substrate;
cathode electrode film;
electronic and ion conductive film forming part of the cathode current collector;
electrolyte film;
anode electrode film;
anode current collector; and passivation film and redistribution film.

Other films may be interposed between the cathode (cathode electrode film) and the front collector (the electronic and ion conductive film forming part of the cathode current collector), and/or between the front collector and the electrolyte (electrolyte film). Such films are illustrated in FIG. 3.

These films are likely to contribute to improve chemical performance (preventing chemical degradation) and physical performance (improving adhesion and homogeneity of the lithium flow).

Examples of such films include:
C, In₂O₃, Li1_{.2}Mn_{0.6}Ni_{0.2}O₂, Al₂O₃, ZrO₂, AlPO₄ as described in Y. Lyu et al, Advanced Energy Materials, vol. 11, no 2, p. 2000982, 2021; G. Hu, J. Cao, Z. Peng, Y. Cao, et K. Du, Electrochimica Acta, vol. 149, p. 49-55, December 2014.
Coating of LiCoO₂ in powder form with Li₄Ti₅O₁₂, Li₂TiO₃, TiO₂ as described in Z. Li et al, J. Power Sources, vol. 541, p. 231703, September 2022.
LTO, LLZO, LiTaO₃, LiAlO₂, LiNbO₃, NASICON, etc. as described in A. Banerjee et al., Chem. Rev. vol. 120, no 14, p. 6878-6933 July 2020.

The thickness of such films is between 1 nm and 50 nm.

According to another aspect, the invention also relates to a method for preparing a battery as defined above, which comprises a step of depositing the electronic and ion conductive film on the cathode electrode film.

This deposition can be carried out using techniques well known to the skilled person, in particular thin-film deposition techniques, for example,
by atomic layer etching (ALE),
by atomic thin layer deposition or ALD,
by depositing films by evaporation,
by depositing films by sputtering,
by electrodeposition of films.

The other elements of the battery can be installed using one of the techniques well known to those skilled in the art, described for example by {A.C. Kozen et al., Chem. Mater. 2015, 27, 15, 5324-5331; EMF Vieira et al, E.M.F. Vieira et al., J. Phys. D: Appl. Phys, 2016, 49, 48, 5301 (; WO 2008019398A1}.

According to another aspect, the invention also relates to the use of a battery according to the invention, as a solid battery, in particular as an integrated solid state micro-battery, to power an electrical device, in particular a portable device.

This device is, for example, a (bio)medical device, in particular an implantable (bio)medical device, or an electronic entertainment device, in particular an augmented reality device.

### DEFINITIONS

As understood here, the value ranges in the form of “x-y” or “from x to y” or “between x and y” include the x and y terminals, as well as the integers between these terminals. For example, “1-5”, or “from 1 to 5” or “between 1 and 5” refer in particular to the integers 1, 2, 3, 4 and 5. The preferred embodiments include each individual integer in the value range, as well as any sub-combination of those integers. For example, the preferred values for “1-5” may comprise the integers 1, 2, 3, 4, 5, 1-2, 1-3, 1-4, 1-5, 2-3, 2-4, 2-5, etc.

As used in this description, the term “about” refers to a range of values within ±10% of a specific value. For example, the term “about 20” comprises the values of 20±10%, i.e., the values of 18 to 22.

For the purposes of this description, the percentages refer to percentages by mass in relation to the total mass of the formulation, unless otherwise stated.

By film, it is understood in particular a stratum of superimposed or stacked elements.

### FIGURES

FIG. 1 illustrates a cross-sectional view of a battery obtained according to the examples of this application.

FIG. 2 shows a cross-sectional view of a battery obtained according to the examples of this application, in which the anode is shown.

FIG. 3 illustrates a battery whose electronic and ion conductive film consists of or comprises an electronic conductive material (a metal grid, e.g. Pt) and an ion conductive material (solid electrolyte, e.g. LiPON). A and C to H: cross-sectional view of batteries in which the electronic conductive film is not continuous. B: top view of said film according to A.

FIG. 4 shows a cross-sectional view of a battery according to the invention comprising two stabilization films, one between the cathode (cathode electrode film) and the front collector (the electronic and ion conductive film forming part of the current collector of the cathode), and the other between the front collector and the electrolyte (electrolyte film).

### EXAMPLES

A thin-film solid-state battery according to the invention is prepared as follows. A 100 nm thick amorphous TiO₂ film (cathode current collector) is deposited by ALD on a 20 μm thick cathode film of LiCoO₂. A film of LIPON electrolyte (1 μm thick) and a Ti anode current collector are added to obtain the active part of the battery.

The other battery elements (support: SiO₂, passivation film: PPX, contact recovery film: Ti), have been set up as known to the skilled person.

The gain in capacity at 1 mA·cm⁻² is approximately +0.4 mA·cm⁻², i.e. a gain of +50% compared with the prior art (current collector placed under the cathode film, which is also in contact with the electrolyte film).

In addition, capacitance retention is much more stable, with a loss of only 10% between 0.1 and 10 mA·cm⁻², compared with 30% in the prior art.

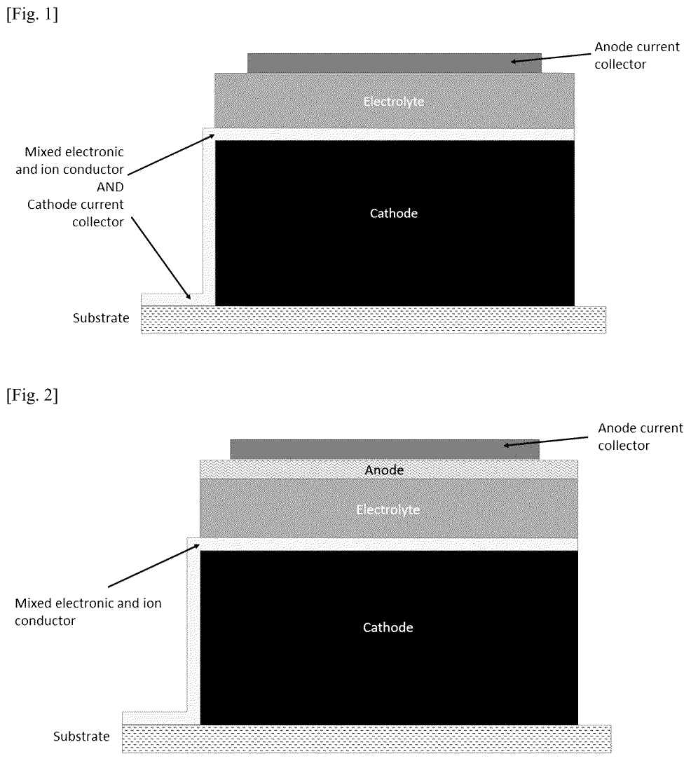

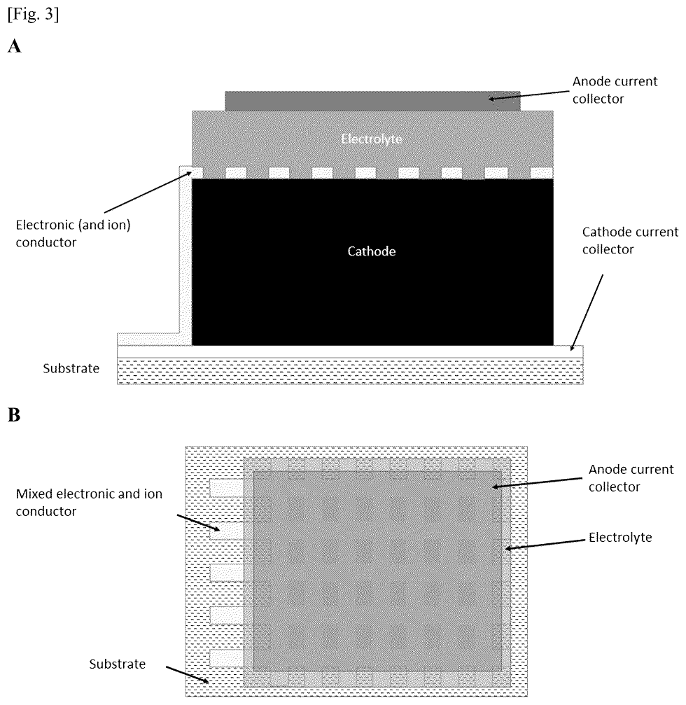

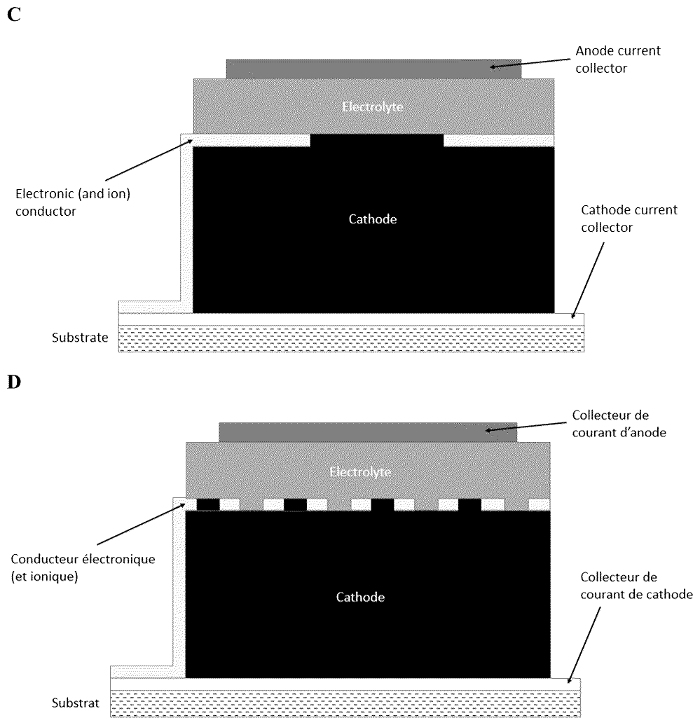

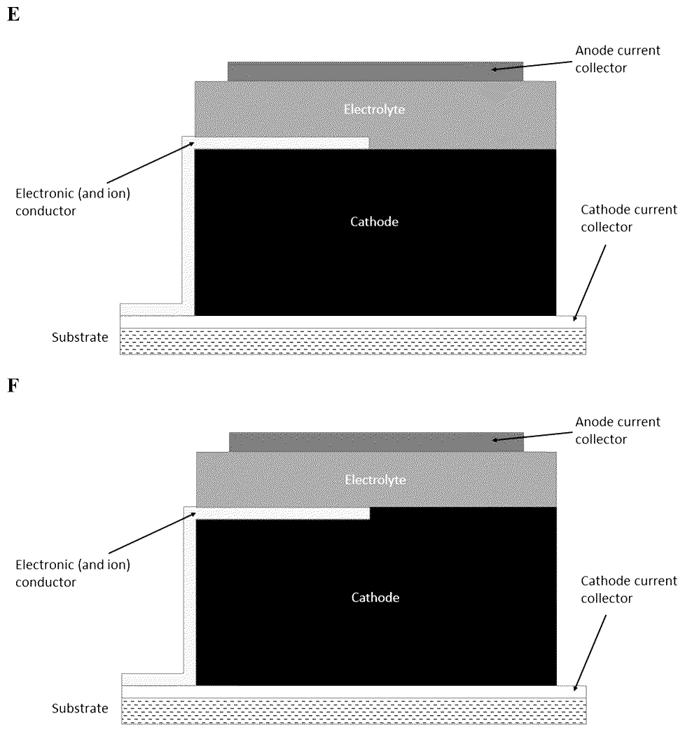

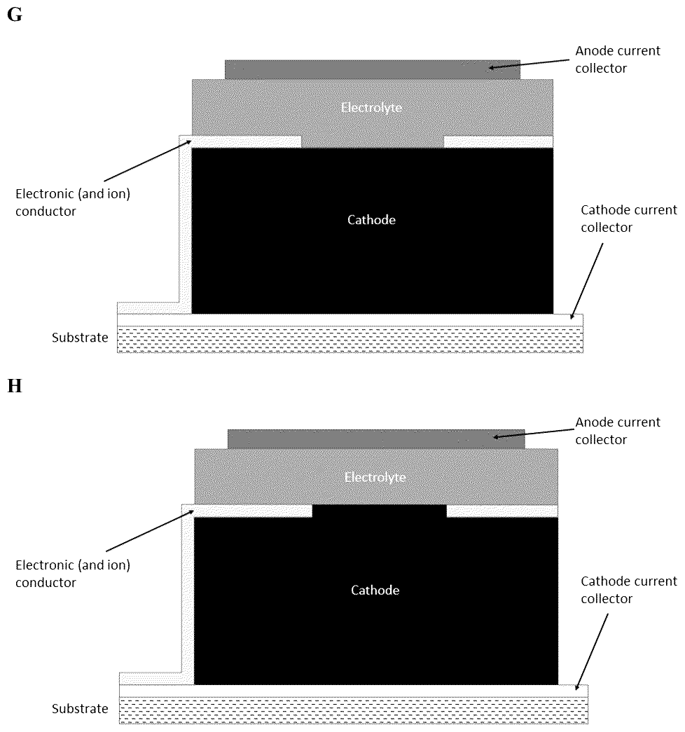

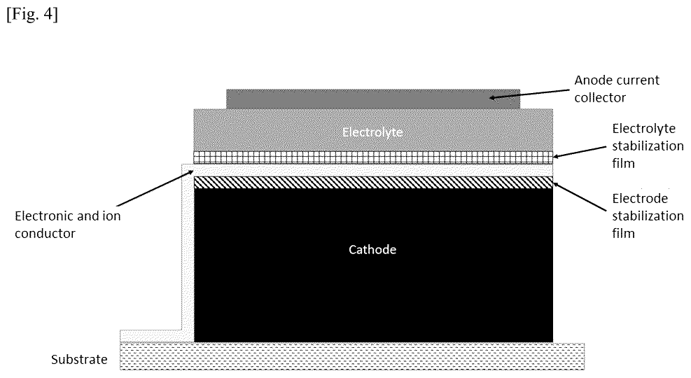

FIG. 1 shows an example of a battery produced in this way.

1. A solid-state battery comprising an electronic and ion conductive film between an electrolyte film and an electrode film,
said electronic and ion conductive film forming part of the current collector of the electrode, and
allowing partial contact between the electrolyte and the electrode, possibly via an ion and optionally electronic conductive material.

2. The battery according to claim 1, comprising:
an anode current collector in contact with an electrolyte film;
an electronic and ion conductive film separating the electrolyte film from a cathode electrode film;
said electronic and ion conductive film forming part of the cathode current collector.

3. The battery of claim 1, comprising:
an anode current collector in contact with an anode electrode film;
an electrolyte film in contact with the anode electrode film;
an electronic and ion conductive film separating the electrolyte film from a cathode electrode film;
said electronic and ion conductive film forming part of the cathode current collector.

4. The battery according to claim 1, wherein the electronic and ion conductive film has a thickness of 10 nm to 1 μm.

5. The battery according to claim 1, wherein the cathode electrode film has a thickness E of from 1 μm to 200 μm.

6. The battery according to claim 5, wherein the electronic and ion conductive film has a thickness of from 10 nm to E/2, E being the thickness of the cathode electrode film as described in claim 5.

7. The battery according to claim 1, wherein said electronic and ion conductive film comprises an electric and ion conductive material selected from:
The optionally doped metals selected from Si, Sn, Al, As, and their alloys;
The carbon-based materials, selected from the mesocarbon microbeads (MCMB), highly ordered pyrolytic graphite (HOPG), hard carbons and soft carbons;
LiTiO₂; and/or
LiFePO₄.

8. The battery according to claim 1, wherein said electronic and ion conductive film comprises at least one electronic conductive material and at least one ion conductive material,
said at least one electronic conductive material being chosen from the metals Pt, W, Al, Cu, Au and Ti, particularly in the form of a grid, and/or
said at least one ion conductive material being selected from the solid electrolytes LiPON, LLTO, LLZO, LPS, LTP, LZP, LiSiON, LAGP, LGPS, and optionally PEO-based, and
the solid electrolyte constituting or comprised in the electrolyte film as defined in claim 1.

9. A method of preparing a battery according to claim 1, which comprises a step of depositing the electronic and ion conductive film on the cathode electrode film.

10. The method according to claim 9, the deposition step is carried out by atomic layer etching.
